(19) United States
(12) Patent Application Publication
(10) Pub. No.: US 2015/0358353 A1
(43) Pub. Date: Dec. 10, 2015

(54) ENHANCED SELECTIVE WIPE FOR COMPROMISED DEVICES

(71) Applicant: Microsoft Corporation, Redmond, WA (US)

(72) Inventors: Mihai Costea, Redmond, WA (US); Mahesh K. Unnikrishnan, Sammamish, WA (US); Uday S. Hegde, Bellevue, WA (US)

(21) Appl. No.: 14/528,727

(22) Filed: Oct. 30, 2014

Related U.S. Application Data
(60) Provisional application No. 62/009,086, filed on Jun. 6, 2014.

(51) Int. Cl. H04L 29/06; G06F 21/62

(52) U.S. Cl. CPC H04L 63/20; H04L 63/08; G06F 21/6209

(57) ABSTRACT

Systems, methods, and software are disclosed herein that enhance selective wipe technology and operations. In an implementation, an application initiates a request to authenticate a user with respect to the application. In some scenarios, the application receives a response to the request that includes a selective wipe instruction. Then the application receives such a response, the application selectively wipes data associated with the application.

### RELATED APPLICATIONS

This application claims priority to, and incorporates by reference in its entirety, U.S. Provisional Application No. 62/009,086, filed on Jun. 6, 2014, and entitled “Selective Wipe for Compromised Devices.”

### TECHNICAL BACKGROUND

An ever greater variety of devices are used by workforce personnel for accessing high value enterprise data such as email or documents stored on enterprise servers or clouds. Even in non-work related settings and scenarios, individuals access their personal data using a variety of computing devices.

This increase in access comes with additional exposure to data loss in case devices are misplaced, when members of a work force are no longer associated with their company, or in the event of theft. In these and other cases, an organization or individual may be interested in purging enterprise data or other select data from the devices in question.

Selective wipe is a computing technology that allows certain applications and profiles to be removed when a device becomes compromised, while preserving other data. For example, enterprise applications and profiles installed on a user's device may be removed automatically when the device becomes compromised, while the user's personal data can remain in-tact.

Such technology is especially useful in bring-your-own-device scenarios where employees utilize their personal computing device for both work and personal purposes. In the event that they are separated from the enterprise or their device becomes lost, stolen, or just misplaced temporarily, the enterprise can protect its data without doing harm to the user's personal data.

Most selective wipe implementations involve a device manager service that communicates with specialized clients installed end-user devices. When a device becomes compromised, it is reported to the service. The service then communicates with the client installed on the compromised device in order to initiate a wipe of select data. The selected data may be enterprise data, for example, as opposed to personal data.

### OVERVIEW

Provided herein are systems, methods, and software that enhance selective wipe technology. In an implementation, an application initiates a request to authenticate a user with respect to the application. In some scenarios, the application receives a response to the request that includes a selective wipe instruction. Then the application receives such a response, the application selectively wipes data associated with the application.

In at least one implementation, a primary selective wipe process may be initiated on a device by a device management client instructed by a device management service. The primary selective wipe process may be followed by a secondary selective wipe process initiated via a request to authenticate a user and a corresponding response to the authentication request.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture in the context of which enhanced selective wipe may be employed in an implementation.

FIG. 2 illustrates a selective wipe process that may be employed by an online service in an implementation.

FIG. 3 illustrates a selective wipe process that may be employed by a local application in an implementation.

FIG. 4 illustrates an operational scenario involving enhanced selective wipe in an implementation.

FIG. 5 illustrates another operational architecture in which enhanced selective wipe may be employed in an implementation.

FIG. 6A illustrates an operational scenario in an implementation.

FIG. 6B illustrates an operational scenario in an implementation.

FIG. 7A illustrates an operational scenario in an implementation.

FIG. 7B illustrates an operational scenario in an implementation.

FIG. 8 illustrates an operational scenario in an implementation.

FIG. 9 illustrates a computing system suitable for implementing any of the applications, architectures, services, processes, and operational scenarios disclosed herein with respect to FIGS. 1-8 and discussed below in the Technical Disclosure.

### TECHNICAL DISCLOSURE

Implementations of enhanced selective wipe disclosed herein leverage the authentication channel between an application and a service to trigger a selective wipe process. A selective wipe instruction may be communicated via the authentication channel to the application, thereby triggering the application to remove selected data from the device. The authentication channel may also be used for communicating other device management instructions and operations, in addition to or other than selective wipe.

In a brief example, when a device is not compromised, an application on the device may communicate with an application service to interact with, obtain, or otherwise provide a user with features and functionality of the application and service. As part of this interaction, the application may also communicate with an authorization and authentication service in order to ensure that the user is authenticated and/or is authorized to use the application service.

However, the device may become compromised at some point. For example, the device may be lost, stolen, or misplaced, or the user associated with the device may become separated from an enterprise or other such organization. When this happens, the compromised state of the device may be reported and enhanced selective wipe processes employed to ensure that sensitive data is protected.

For instance, when the application initiates a request to authorize or authenticate a user with respect to the application (or both), a corresponding authorization and authentication service may communicate a response to the request that includes a selective wipe instruction. The response may be, for example, a denial of access to an application service corresponding to the application.

When received by the application, the response triggers the application to selectively wipe data associated with the application. The data associated with the application may include enterprise data and personal data. To selectively wipe the data associated with the application, the application may remove the enterprise data while preserving the personal data. In some cases the application may track which of the data associated with the application is the enterprise data and which of the data associated with the application is the personal data, so as to facilitate selective wipe.

In some scenarios, a user associated with a given device may be associated with more than one enterprise. As such, the user's device may very well have data on it that is associated with multiple enterprises. For example, the user may be associated with a university as well as a corporation. Thus, the user's device may have data on it that is associated with the university and data associated that is with the corporation, as well as the user's own personal data.

Implementations disclosed herein allow either one of the enterprises to selectively wipe their own data without deleting the data of the other enterprise. The university may initiate a selective wipe operation via an access control service that removes the data associated with the university, without harming the corporate data or the personal data. The corporation may also initiate their own selective wipe operation that removes corporate data, without harming the university data or personal data.

In some implementations, such enhanced selective wipe may co-exist (and even cooperate) with existing or modified selective wipe operations. In an example, a device may include an application or applications with enhanced selective wipe capability, but may also include, in addition to those applications, a device management application that interacts with a device management service. In such scenarios, when a device becomes compromised, the device management service instructs the device management application to carry out a selective wipe process of its own.

In a scenario where a device management application is present on a device, the device management application may (but not always) perform a primary selective wipe process directed to removing line-of-business applications, profiles, and other data that is visible to the device management application. A selective wipe process carried out by an application other than the device management application, which is triggered by an authentication and authorization service or process, may be capable of removing data that is not visible to or accessible by the device management application. Examples of such data include files created when interacting with online services, such as a productivity service, cloud storage service, personal information management service, and a collaboration service. In addition, the secondary selective wipe process may prevent files from syncing down to the compromised device after the primary selective wipe process has been performed.

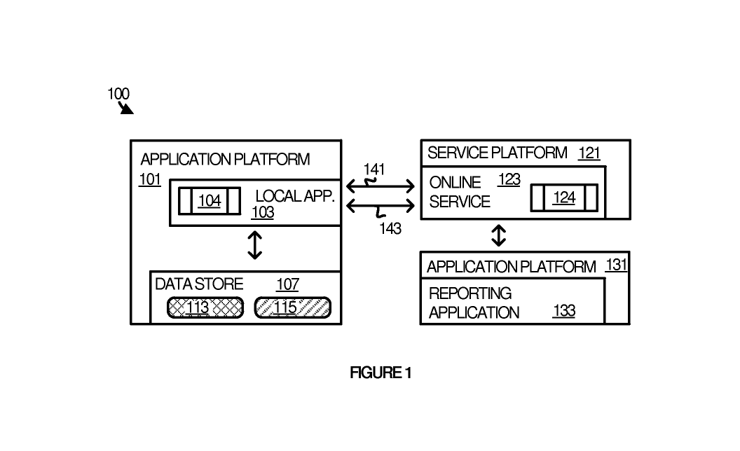

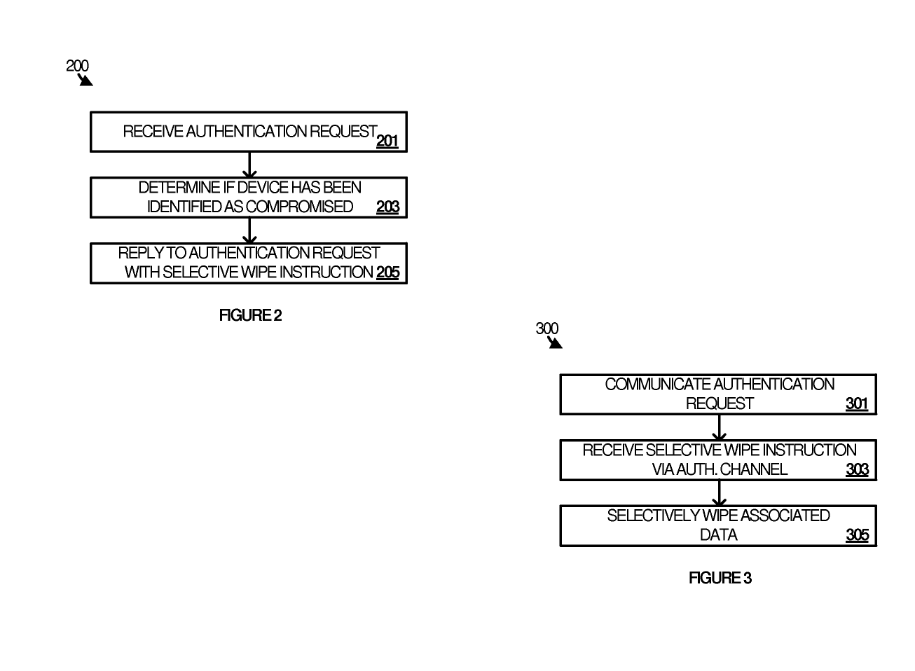

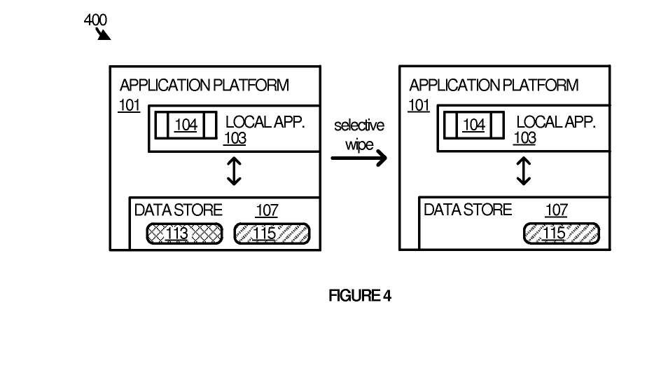

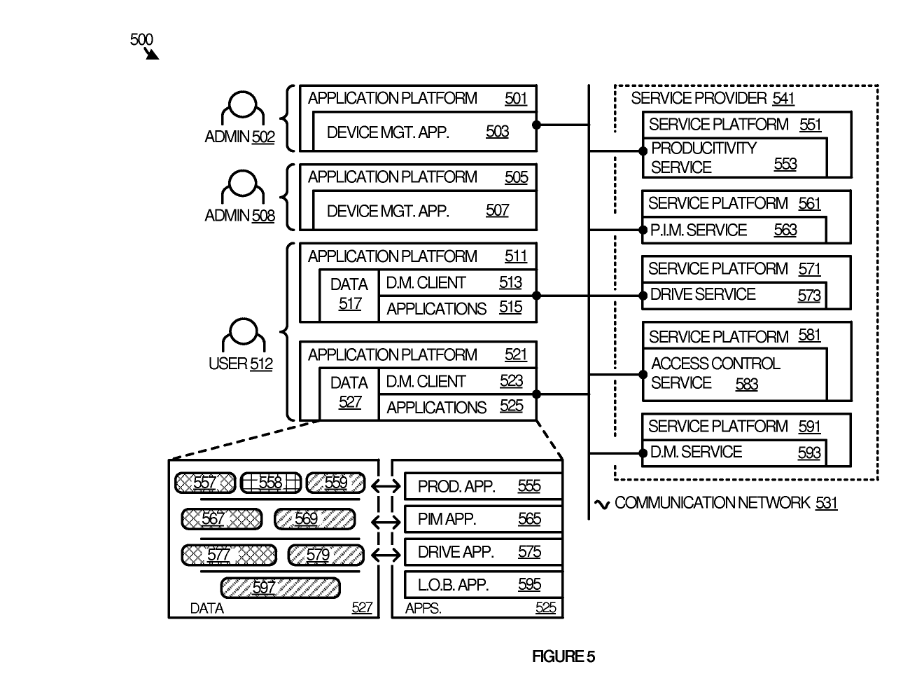

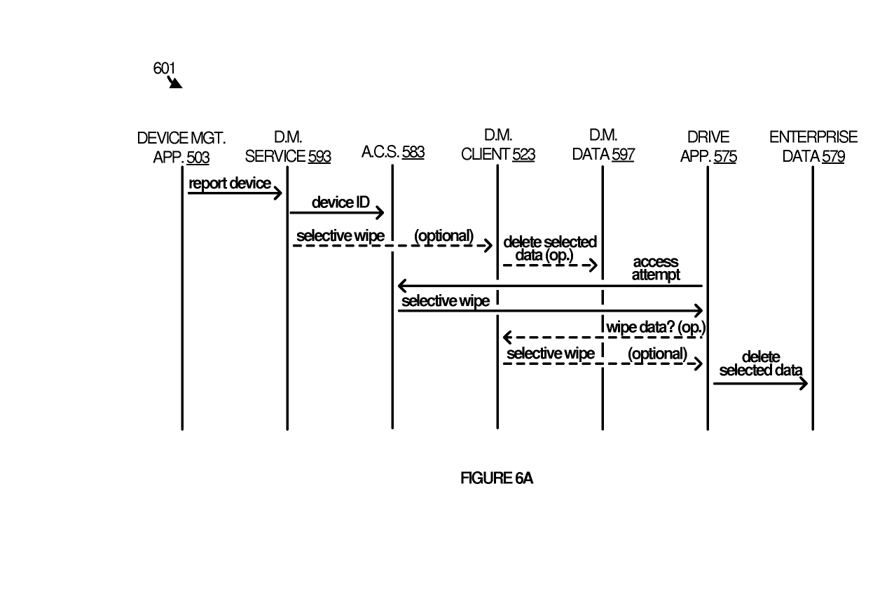

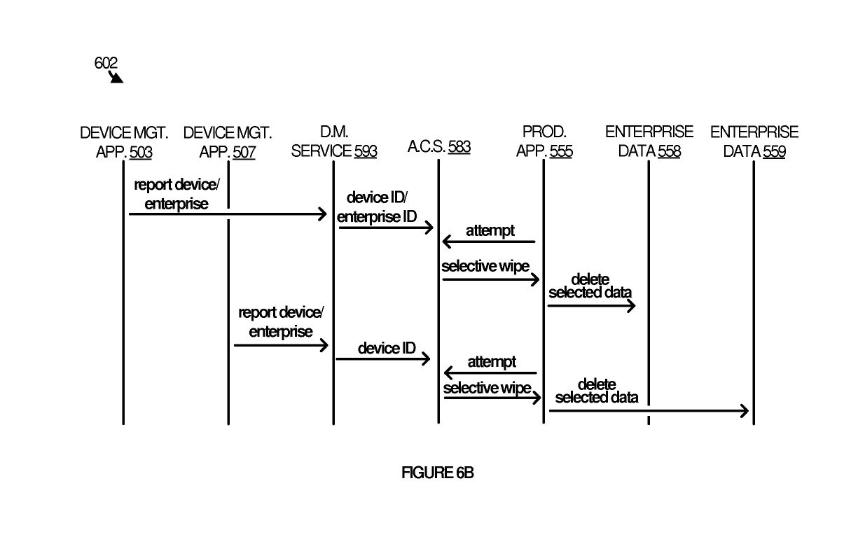

To further illustrate enhanced selective wipe, a discussion of FIGS. 1-9 follows. FIG. 1 illustrates an operational architecture in an implementation of enhanced selective wipe. FIG. 2 illustrates a selective wipe process that may be employed by a service found in the operational architecture, while FIG. 3 illustrates a selective wipe process as employed by an application in the architecture. FIG. 4 illustrates an example scenario of enhanced selective wipe. FIG. 5 illustrates another operational architecture and FIGS. 6A-8 illustrate various operational scenarios with respect to the architecture. FIG. 9 illustrates a computing system representative of any system or systems suitable for implementing the applications, processes, architectures, and services discussed herein.

Referring to FIG. 1, operational architecture 100 includes application platform 101, service platform 121, and application platform 131. Local application 103 runs on or otherwise within the context of application platform 101. Local application 103 stores data 113 and data 115 in data store 107. Data 113 is representative of data that may be associated with an enterprise or a specific identity such that it can be selectively wiped. Data 115 is representative of data that is not associated with the enterprise or the specific identity and thus could be retained even while data 113 is wiped. Service platform 121 hosts online service 123 and application platform 131 hosts reporting application 133.

In operation, local application 103 interfaces with online service 123 in order to carry out various features and functionality of the application. As part of said operations, local application 103 may communicate with online service 123 in at least two stages, represented by stage 141 and stage 143. In the first stage, stage 141, local application 103 may engage in an authentication and/or authorization stage to, for example, obtain access to online service 123 on behalf of a specific user. Once authenticated and/or authorized, local application 103 may communicate with online service 123 during stage 143 to, for example, gain access to the various features and functionality provided by online service 123.

During the first stage, online service 123 employs selective wipe process 124. FIG. 2 includes a flow diagram 200 that illustrates steps representative of the functionality provided by selective wipe process 124 in some implementations. Process 124 may be embodied in program instructions executed by a computing system suitable for implementing in a service, such as online service 123. Selective wipe process 124 may be integrated in online service 123, although in some implementations selective wipe process 124 may be separate from online service 123 or distributed across multiple services.

Referring to FIG. 2, upon local application 103 attempting to authenticate a user, online service 123 receives an authentication request (step 201). Online service 123 responsively determines whether or not a device (application platform 101) associated with the authentication request has been identified as compromised (step 203). If the device is identified as compromised, online service 123 replies with a selective wipe instructions (step 205) to wipe selected data.

Reporting application 133 may communicate with online service 123 to identify those devices that may be compromised. An administrator or other such personnel engaged with reporting application 133 via application platform 131 can report a given device when it is misplaced, lost, or stolen, for example. In some scenarios, it may be the same user of application platform 101 that utilizes reporting application 133 to report that a device (application platform 101) has been compromised. In other scenarios, still another device (not shown) may communicate with reporting application 133 to report a device as compromised, which may then communicate that fact to online service 123.

Regardless of the mechanism with which a device may be reported as compromised, online service 123 stores the identity of the device and its compromised status such that it may be referenced when local applications attempt to authenticate on behalf of the user. Such authentication attempts may identify the specific device being used to make the authentication attempt. This allows online service 123 to first check on whether or not the device has been compromised.

Rather than returning a valid token for local application 103, online service 123 may provide a code that, when recognized by local application 103, triggers local application 103 to delete data that can be selectively identified as associated with the application, the user, or some other delineation that separates data 113 from other data, such as data 115.

In the same context, local application 103 employs selective wipe process 104 on its end. Selective wipe process 104 may be executed within the process of a start-up or launch sequence for local application 103, a refresh sequence, a synch sequence, or any other operations that include an attempt to authenticate and/or authorize the user, the device, or both, or some other element that may be authenticated.

FIG. 3 includes a flow diagram 300 that illustrates steps representative of the functionality provided by selective wipe process 104 in some implementations. Selective wipe process 104 may be embodied in program instructions executed by a computing system suitable for implementing in an application, such as local application 103. Selective wipe process 104 may be integrated in local application 103, although in some implementations selective wipe process 104 may be separate from local application 103 or distributed across multiple programs, application modules, or software layers.

Referring to FIG. 3, local application 103 communicates an authenticate request to online service 123 in an attempt to authenticate a user (step 301). In the event that the user is successfully authenticated and the device from which the request is sent is not compromised, a valid token may be returned that allows local application 103 to proceed under normal conditions. However, in the event that the device has been identified as compromised, a selective wipe instruction may be communicated by online service 123 that is received by local application 103 (step 303). In response to the selective wipe instructions, local application 103 deletes, removes, encodes, or otherwise “wipes” selectively-identified data so that the data is no longer readable usable in at least most practical respects (step 305).

While FIG. 1 illustrates selective wipe process 104 as implemented within local application 103, it may be appreciated the selective wipe process 104 could be implemented as a stand-alone application or module separate from or external to local application 103. For example, selective wipe process 104 could be integrated with an operating system, a web browser, or some other application. Optionally, the functionality of selective wipe process 104 could be distributed across multiple applications.

FIG. 4 illustrates operational scenario 400 to further explain various aspects of enhanced selective wipe. In operation, local application 103 stores data 113 in data store 107, as well as data 115. As mentioned, data 113 is delineated from data 115 in that data 113 is associated with an enterprise or other identity, while data 115 is not. Thus, data 113 can be targeted for deletion via an authentication process while data 115 can be retained.

In an example, local application 103 may represent an email application while data 113 may represent an email database associated with an enterprise email address or account. Data 115 may represent another email database or account that is not associated with the enterprise. In such an example, online service 123 may represent an email service associated with the enterprise and with which the email application communicates to authenticate a user. Data 113 may thus be authenticated by the service associated with the enterprise, thereby distinguishing it with respect to data 115 that may be authenticated by another service not related to the enterprise, or not at all.

In another example, local application 103 may represent an enterprise-grade cloud storage application while data 113 may represent data stored by the cloud storage application and in association with an enterprise. In such an example, online service 123 may represent a cloud storage service with which the cloud storage application communicates to authenticate the user. By comparison, data 115 may be associated with a local file system location (i.e. the desktop) or another cloud storage service not associated with the enterprise. As such, data 113 can be deleted due to its association with the enterprise while data 115 can be retained. In this manner, enterprise can be removed while personal data can be retained.

In yet another example, local application 103 may represent a productivity application (such as a word processing application) while data 113 may represent productivity documents and the like that are generated, created, or otherwise produced in association with an enterprise identity. In such an example, online service 123 may represent a productivity service or collaboration service with which the productivity application communicates to authenticate a user. The productivity documents may thus be authenticated against the user, thereby distinguishing them from other data, represented by data 115. Data 115 may be produced via some other identity that is not targeted for selective wipe, or no specific identity at all.

Returning to operational scenario 400, local application 103 may attempt to authenticate the user. This may occur when local application 103 is launched or periodically throughout its operation. In this scenario, it is assumed that authentication fails, and more particularly that a selective wipe application is returned in response to the authentication attempt. Local application 103 responsively deletes data 113, but data 115 is not deleted. In this manner, data associated with a user's enterprise identity or some other delimitated identity can be removed without harming other data. The other data may be personal data, for example, that the user may not want destroyed.

Referring back to FIG. 1, application platform 101 is representative of any physical or virtual computing system, device, or collection thereof capable of running local application 103 and implementing selective wipe process 104. Examples of application platform 101 include, but are not limited to, smart phones, laptop computers, tablet computers, desktop computers, hybrid computers, gaming machines, smart televisions, virtual machines, and wearable devices, as well as any variation or combination thereof, of which computing system 901 illustrated in FIG. 9 is representative.

Local application 103 is representative of any software application, module, component, or collection thereof, capable of implementing selective wipe process 104. Examples of local application 103 include, but are not limited to, email applications, cloud storage application, productivity applications, calendar applications, real-time communication applications, blogging and micro-blogging applications, social networking applications, e-commerce applications, and gaming applications, as well as any other type of application capable of performing selective wipe process 104.

Local application 103 may a locally installed and executed application, a streamed application, a mobile application, or any combination or variation thereof. In some implementations local application 103 may be a browser-based application that executes in the context of a browser application. Local application 103 may be implemented as a stand-alone application or may be distributed across multiple applications.

Service platform 121 is representative of any physical or virtual computing system, device, or collection thereof capable of hosting all or a portion of online service 123. Examples of service platform 121 include, but are not limited to, server computers, web servers, application servers, rack servers, blade servers, virtual machine servers, or tower servers, as well as any other type of computing system, of which computing system 901 illustrated in FIG. 9 is representative. In some scenarios, online service 123 may be implemented in a data center, a virtual data center, or in some other suitable computing facility. Examples of online service 123 include, but are not limited to, web services, email services, real-time communication services, blogging and micro-blogging services, social networking services, e-commerce services, productivity application service, cloud storage services, and gaming applications, as well as any other type of service, combination of services, or variations thereof.

Online service 123 may be representative of an individual service, but may also be representative of a collection of online services. For example, online service 123 may include an authorization and authentication service, as well as a line service, such as an email service, cloud storage service, productivity service, and the like. In some scenarios, online service 123 includes an authorization and authentication services that provides authentication and authorization for multiple line services. For instance, the authentication and authorization service may handle authentication and authorization for an email service, a productivity service, and a cloud storage service in an integrated manner.

Application platform 131 is representative of any physical or virtual computing system, device, or collection thereof capable of running reporting application 133 and interfacing with online service 123. Examples of application platform 131 include, but are not limited to, smart phones, laptop computers, tablet computers, desktop computers, hybrid computers, gaming machines, smart televisions, virtual machines, and wearable devices, as well as any variation or combination thereof, of which computing system 901 illustrated in FIG. 9 is representative. Other examples include server computers, web servers, application servers, rack servers, blade servers, virtual machine servers, or tower servers, as well as any other type of computing system.

Reporting application 133 is representative of any software application, module, component, or collection thereof, via which a user may report a device as compromised. Examples of reporting application 133 include, but are not limited to, administrative portals used by administrative personnel, websites through which a user may report a compromised device, voice response systems capable of interfacing with a user over a voice connection (such as a telephone call) to report a device as compromised, an email or text message system for receiving notification of a compromised device, or any other system or systems through which a compromised device may be reported to online service 123.

FIG. 5 illustrates operational architecture 500 in an implementation of enhanced selective wipe. Operational architecture 500 includes application platform 501, application platform 505, application platform 511, and application platform 521 that host applications that interact with service provider 541. Service provider 541 includes service platform 551, service platform 561, and service platform 571 that host productivity service 553, personal information management service 563, and drive service 573 respectively. Access to the application services included in service provider 541 is governed by access control service 583 hosted on service platform 581. The various application platforms and service platforms in operational architecture 500 communicate via a communication network or networks, of which communication network 531 is representative.

Device management application 503 runs on application platform 501 and provides an administrator 502 or other personnel with a portal to device management service 593, which runs on service platform 591. Administrator 502 may interact with the portal to report when a device has become compromised, set policy, and the like. Administrator 502 may be associated with a particular enterprise, such as a university, corporation or other entity. As such, administrator 502 may report that a device has become compromised when the device has been lost or a person associated with it separated from the enterprise.

Device management application 507 runs on application platform 505 and provides an administrator 508 or other personnel with a portal to device management service 593. Administrator 508 may interact with the portal to report when a device has become compromised, to set policy, and the like. Administrator 508 may be associated with a particular enterprise, such as a university, corporation or other entity other than the enterprise associated with enterprise 502. Administrator 508 may report that a device has become compromised when the device has been lost or a person associated with it separated from the enterprise, for example.

Application platform 511 includes a device management client 523 that communicates with device management service 593 to facilitate device management operations, including selective wipe operations. Application platform 511 also includes applications 525 via which user 512 may access various application services, including productivity service 553, personal information management service 563, and drive service 572 (sometimes referred to as a cloud storage service). Data 517 is representative of the data that may be associated with device management client 523 and applications 525.

User 512 may also access the application services via applications 525 on application platform 521. Examples of applications 525 includes productivity application 555, personal information management application 565, drive application 575 (sometimes referred to as a cloud storage application), and a line-of-business application 595.

Data 527 is representative of the data that may be associated with applications 525. Portions of data 527 may be enterprise data, while other portions may be personal data, as indicated by different fill patterns for enterprise data relative to personal data.

For example, data 527 includes personal data 557, enterprise data 558, and enterprise data 559 associated with productivity application 555. Personal data 567 and enterprise data 569 represents data associated with personal information management application 565. Data 527 also includes personal data 577 and enterprise data 579 associated with drive application 575. Device management data 597 represents data associated with line-of-business application 595 and possibly other data that may be accessible by device management client 523.

Application platforms 501, 505, 511, and 521 are each representative of any computing system or systems capable of employing device management application 503, device management clients 513 and 523, and applications 515 and 525 respectively. Examples include desktop computers, laptop computers, tablet computers, mobile phones, smart phones, phablets, gaming systems, smart televisions, wearable devices (such as smart watches and smart glasses), virtual machines, and server computers, as well as any other type of computing system or systems, combinations thereof or variations, of which computing system 901 in FIG. 9 is representative.

Service platforms 551, 561, 571, 581, and 591 are each representative of any computing system or systems capable of employing the various application services and device management service included in service provider 541. Examples include server computers, blade servers, virtual servers, rack servers, web servers, cloud computing platforms, and data center equipment, as well as any other type of physical or virtual server machine, and any variation or combination thereof, of which computing system 901 illustrated in FIG. 9 is representative.

FIG. 6A illustrates an operational scenario 601 that demonstrates various aspects of enhanced selective wipe technology. In operation, administrator 502 reports through device management application 503 that a device has been compromised. In this example, the compromised device is application platform 521. Device management application 503 reports the compromised device to device management service 593.

Device management service 593 identifies the compromised device to access control service 583. Optionally, device management service 593 may also communicate a selective wipe instruction to device management client 523. In the event that a selective wipe instruction is communicated to device management client 523, device management client 523 may proceed to delete selected data from device management data 597.

Further in operation, an application may attempt to access an application service, which includes communicating with access control service 583. In this example scenario, drive application 575 attempts to access drive service 573, which includes communicating initially with access control service 583 in the context of an authorization process, an authentication process, or the like.

In response to the access attempt, access control service 583 communicates a selective wipe instruction to drive application 575. In some optional implementations, drive application 575 may communicate with device management client 523 to ascertain whether or not to wipe selected data. In such scenarios, device management client 523 may confirm that selective wipe is appropriate and instructs drive application 575 to proceed. In either case, drive application 575 may proceed to delete enterprise data 579.

It may be appreciated that the flow illustrated in operational scenario 601 may occur repeatedly whenever drive application 575 makes an access attempt. This may occur when, for example, drive application 575 is attempting to synchronize data. In this manner, drive service 573 may be prevented from synching down data to a compromised device. At the same time, user 512 is still able to access his or her data and services via application platform 511.

FIG. 6B illustrates an operational scenario 602 that demonstrates how multiple enterprises may be able to selectively wipe data on a single device. In operation, administrator 502 reports through device management application 503 that a device has been compromised. In this example, the compromised device is application platform 521. Device management application 503 reports the compromised device and its associated enterprise to device management service 593. Device management service 593, in turn, identifies the compromised device to access control service 583 and also identifies the enterprise associated with the administrator who reported the device.

Productivity application 555 may attempt to access productivity service 553, which includes communicating with access control service 583 in the context of an authorization process, an authentication process, or the like. In response to the access attempt, access control service 583 communicates a selective wipe instruction to productivity application 555. Productivity application 555 then proceeds to delete enterprise data 558, which is associated with the enterprise that initiated the selective wipe process.

Further in operation, administrator 508 reports through device management application 507 that a device has been compromised. In this example, the compromised device is application platform 521. Device management application 507 reports the compromised device and its associated enterprise to device management service 593. Device management service 593, in turn, identifies the compromised device to access control service 583 and also identifies the enterprise associated with the administrator who reported the device.

Productivity application 555 may attempt again to access productivity service 553, which includes communicating with access control service 583 in the context of an authorization process, an authentication process, or the like. In response to the access attempt, access control service 583 communicates a selective wipe instruction to productivity application 555. Productivity application 555 then proceeds to delete enterprise data 559, as it is associated with the enterprise that initiated the selective wipe.

It may be appreciated from FIG. 6B that multiple, different enterprises may initiate separate selective wipe processes that result in different enterprise data being deleted. In the first instance, one enterprise removes enterprise data 558, while in the second instance, a different enterprise selectively removes enterprise data 559.

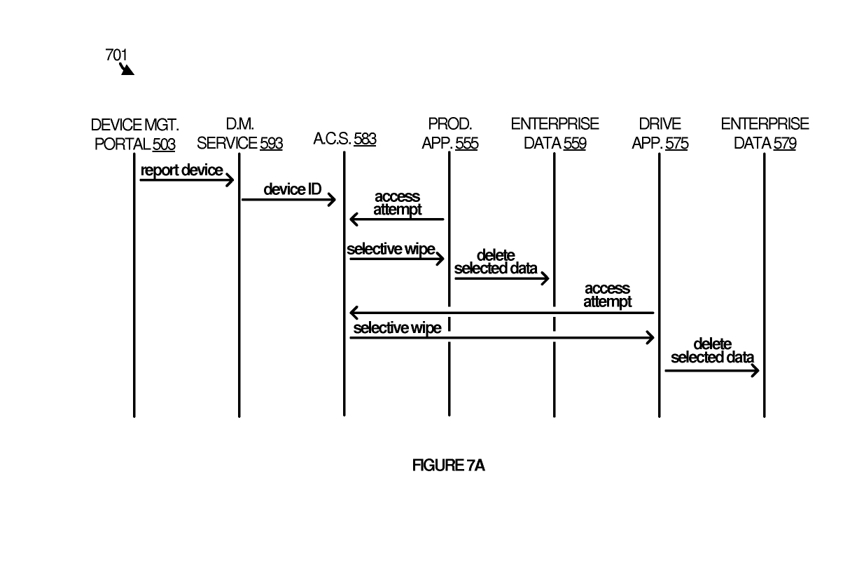

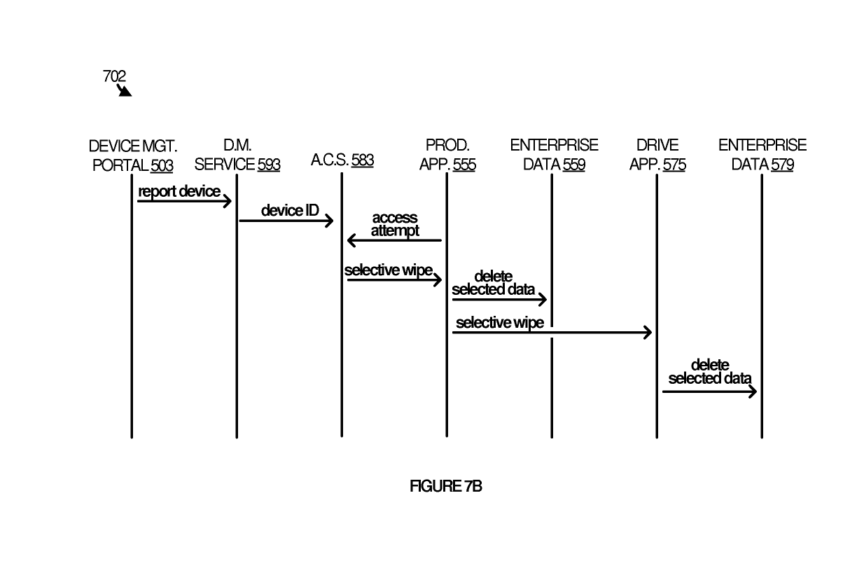

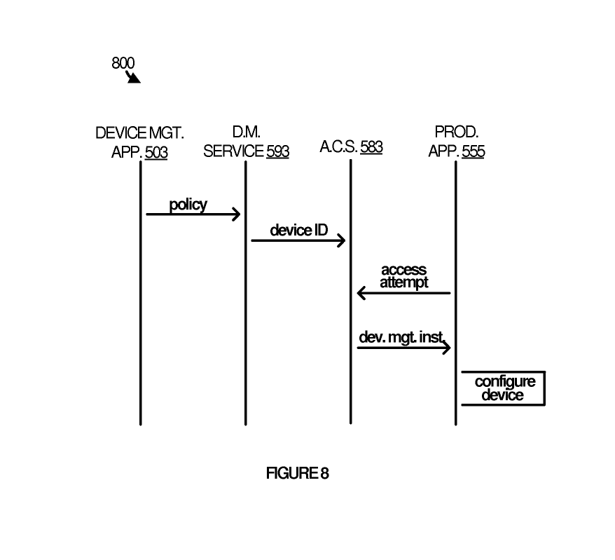

FIG. 7A illustrates another operational scenario 701 that demonstrates various other aspects of enhanced selective wipe technology. In operation, administrator 502 reports through device management application 503 that a device has been compromised. In this example, the compromised device is application platform 521.

Device management service 593 identifies the compromised device to access control service 583. In operation, an application may attempt to access an application service, which includes communicating with access control service 583. In this example scenario, productivity application 555 attempts to access productivity service 553, which includes communicating initially with access control service 583 in the context of an authorization process, an authentication process, or the like.

In response to the access attempt, access control service 583 communicates a selective wipe instruction to productivity application 555. Productivity application 555 then proceeds to delete enterprise data 559.

Further in operation, drive application 575 attempts to access drive service 573, which includes communicating initially with access control service 583 in the context of an authorization process, an authentication process, or the like.

In response to the access attempt, access control service 583 communicates a selective wipe instruction to drive application 575. Drive application 575 then proceeds to delete enterprise data 579.

It may be appreciated that the flow illustrated in operational scenario 701 may occur repeatedly whenever productivity application 555 or drive application 575 makes an access attempt. This may occur when, for example, productivity application 555 or drive application 575 is attempting to synchronize data. In this manner, productivity service 553 and drive service 573 may be prevented from synching down data to a compromised device. At the same time, user 512 is still able to access his or her data and services via application platform 511.

FIG. 7B illustrates yet another operational scenario 702 that demonstrates various other aspects of enhanced selective wipe technology. In operation, administrator 502 reports through device management application 503 that a device has been compromised. In this example, the compromised device is application platform 521.

Device management service 593 identifies the compromised device to access control service 583. In operation, an application may attempt to access an application service, which includes communicating with access control service 583. In this example scenario, productivity application 555 attempts to access productivity service 553, which includes communicating initially with access control service 583 in the context of an authorization process, an authentication process, or the like.

In response to the access attempt, access control service 583 communicates a selective wipe instruction to productivity application 555. Productivity application 555 then proceeds to delete enterprise data 559.

Further in operation, productivity application 555 can communicate a selective wipe instruction to drive application 575, in addition to or in place of drive application 575 receiving a selective wipe instruction from access control system 583. The instruction may be a discrete instruction that is pushed to drive application 575, although in some cases drive application 575 may query productivity application 555 (or any other local application). In other cases, drive application 575 may monitor the state of data associated the productivity application 555. When it is selectively wiped, that may serve as a signal to drive application 575 to selectively wipe its own data.

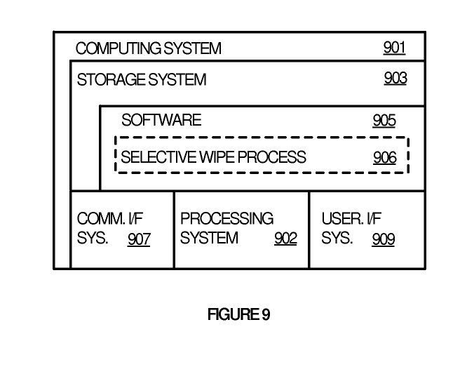

FIG. 8 illustrates an operational scenario 800 that demonstrates that the authentication channel may be used for other operations in addition to or other than selective wipe. In operation, administrator 502 provides a policy through device management application 503 that defines, for example, a configuration for a device when a document or set of documents are opened.

For instance, a policy may define that a device's camera, screen capture capability, or screen sharing capability be disabled when a particular document or set of documents associated with an enterprise are opened. The policy may include other constraints, such as location, time, or data constraints that may be applied when determining how or when to enforce a policy.

Device management application 503 communicates the policy to device management service 593, which in turn provides the identity of a device or devices that may be subject to the policy to access control service 583. When an application is opened on a device, the application attempts to authenticate with access control system 583. Access control system 583, in addition to authenticating the device and/or user associated with the access control system, may communicate a device management instruction to the application. In this example, the application opening or operating on the file is productivity application 555, although applications are possible.

Productivity application 555 receives the device management instruction and responsible executes the instruction to enforce the specified policy. For example, productivity application 555 may its device's camera, screen capture capability, or screen sharing capability.

Operational architecture 500 may support multiple enterprises. While FIG. 5 illustrates administrator 502 associated with one enterprise, it may be appreciated that other administrators associated with other enterprises may be supported. While the operational scenarios discussed above with respect to FIGS. 6-8 illustrate selective wipe processes initiated by administrator 502 on behalf of one enterprise, other selective wipe processes initiated on behalf of other enterprises are possible. For instance, another administrator interacting via another device management application could initiate another selective wipe process to wipe data associated with another enterprise.

Various technical effects may be appreciated from the foregoing implementations. The enhanced “selective wipe” or “enterprise-only wipe” features disclosed herein allow the administrator of a domain (e.g. contoso.com) to trigger removal of contoso.com data from specific devices, while leaving the data that is personal or that belongs to other organizations (university, charity, etc.) intact. In a non-workforce related example, an individual may desire to selectively wipe data associated with only a particular persona or identity that he or she maintains.

Existing solutions include a Mobile Device Management (MDM) feature or service that allows for selective wipe. However, MDM solutions rely on applications implementing a containerization SDK, or using MDM provided mobile clients, each with its own drawbacks. For instance, MDM clients typically introduce a great deal of complexity to an application environment. A client application must track the origin of each data blob so that only Contoso data (or other tracked data) can later be deleted. The client-server application needs to be aware of a DeviceID, in order for a selective wipe command to reach the intended physical device that was lost (and not other devices belonging to the same users). In order to validate a selective wipe signal, the application needs to maintain a mutually authenticated data channel. This conflicts with the best practice of disabling device objects (e.g. in directory stores) once they are not trusted, in order to stop data synchronization to those devices. Blocking data sync in turn blocks authentication and therefore the transmittal of the selective wipe signal.

To advance beyond these and other solutions, the systems, methods and software disclosed herein leverage the authentication process to communicate selective wipe commands. In addition, rather than relying upon a dedicated MDM client, selective wipe functionality may be integrated into a local application. Selective wipe can be applied to data that is associated with that application and that is associated with the authentication authority or process that issues the selective wipe command.

Such enhanced selective wipe technology relies on modifying existing client-server authentication protocols that are device aware (such as the Azure AD implementation of OAuth) to provide a reliable and secured selective wipe signal to devices. In an implementation, this selective wipe signal is associated with the security tokens issued to clients and used for downloading the data/checking for server side updates. This allows the application to use the token marked as “SelectiveWipe” to also enumerate through the local store and delete all files originating from that specific enterprise.

Such a solution may be beneficial for the common arrangement of “single sign-on”, where the same organization (e.g. Microsoft.com) is hosting many services with vastly different URLs (e.g. sdfpilot.outlook.com, msp.oppe.com, Microsoft.com, exchange.microsoft.com, etc.). Knowing which data elements/caches on the client belong to a specific enterprise, when the enterprise hosts so many varied online data repositories, can be a challenge that is mitigated by the usage of authentication tokens for the purpose of selective wipe.

FIG. 9 illustrates computing system 901 that is representative of any system or collection of systems in which the various operational architectures, scenarios, and processes disclosed herein may be implemented. Examples of computing system 901 include, but are not limited to, smart phones, laptop computers, tablet computers, desktop computers, hybrid computers, gaming machines, virtual machines, smart televisions, smart watches and other wearable devices, as well as any variation or combination thereof. Other examples include server computers, rack servers, web servers, cloud computing platforms, and data center equipment, as well as any other type of physical or virtual server machine, and any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes at least selective wipe process 906, which is representative of the selective wipe processes discussed with respect to the preceding FIGS. 1-8, including selective wipe process 104 and 124 and the processes embodied in operational scenarios 601, 602, 701, 702, and 800. When executed by processing system 902 to enhance data wipe capabilities, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. For example, software 905 may include program instructions for implementing enhanced selective wipe and related functionality.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software or other application software, in addition to or that include selective wipe process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to facilitate enhanced selective wipe. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Referring again to FIG. 4 as an example, through the operation of a computing system or systems of which computing system 901 is representative, transformations may be performed with respect to the various scenarios described therein. As an example, data store 107 may initially include data 113 stored therein. Upon receiving a selective wipe signal from an online service, local application 103 deletes data 113 from data store 107, thereby changing its state.

It may be understood that computing system 901 is generally intended to represent a computing system or systems on which software 905 may be deployed and executed in order to implement enhanced selective wipe. However, computing system 901 may also be suitable as any computing system on which software 905 may be staged and from where it may be distributed, transported, downloaded, or otherwise provided to yet another computing system for deployment and execution, or yet additional distribution.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-9 generally depict relatively few users and relatively few instances of service platforms, application platforms, applications, and services, it may be appreciated that the concepts disclosed herein may be applied at scale. For example, the selective wipe processes disclosed herein could be deployed in support of any number of devices, users, data, applications, and instances thereof.

Various improvements to selective wipe technology may be appreciated from the foregoing implementations. The ability to trigger a selective wipe process via an authentication or authorization channels allows selective wipe to proceed even in the absence of communication between a device management service and its clients. In addition, triggering selective wipe via an authentication channel prevents data synchronization process from downloading new copies of recently-wiped data. Such technical effects improve the functioning of selective wipe and improve the ability of enterprises, individuals, and organizations to protect their data.

Certain inventive aspects may be appreciated from the foregoing disclosure, of which the following are various examples.

### EXAMPLE 1

An apparatus comprising: one or more computer readable storage media; and program instructions stored on the one or more computer readable storage media and comprising an application that, when executed by a processing system, directs the processing system to at least: initiate a request to authenticate a user with respect to the application; receive a response to the request that includes a device management instruction; and execute the device management instruction.

### EXAMPLE 2

The apparatus of Example 1 wherein the device management instruction comprises a selective wipe instruction to selectively wipe data associated with the application and wherein the application further directs the processing system to communicate the request to authenticate the user to an access control service that provides authentication and authorization services, wherein the access control service returns the response to the request that includes the device management instruction.

### EXAMPLE 3

The apparatus of Examples 1-2 wherein the program instructions further comprise a device management application that, when executed by the processing system, directs the processing system to selectively wipe other data in response to another selective wipe instruction communicated by a device management service.

### EXAMPLE 4

The apparatus of Examples 1-3 further comprising the processing system configured to execute the program instructions, wherein the application initiates the request to authenticate the user with respect to the application when attempting to synchronize the data associated with the application with a copy of the data maintained by an application service corresponding to the application.

### EXAMPLE 5

The apparatus of Examples 1-4 wherein the data associated with the application comprises enterprise data and personal data, and wherein to selectively wipe the data associated with the application, the application directs the processing system to remove the enterprise data while preserving the personal data.

### EXAMPLE 6

The apparatus of Examples 1-5 wherein the application further directs the processing system to track which of the data associated with the application comprises the enterprise data and which of the data associated with the application comprises the personal data.

### EXAMPLE 7

The apparatus of Examples 1-6 wherein the program instructions further comprise a second application that, when executed by the processing system, directs the processing system to at least: initiate a second request to authenticate the user with respect to the second application; receive a second response to the second request that includes a second selective wipe instruction; and in response to the second request, selectively wipe second data associated with the second application.

### EXAMPLE 8

The apparatus of Examples 1-7 wherein the application comprises a productivity application, a personal information management application, or a cloud storage application.

### EXAMPLE 9

The apparatus of Examples 1-8 wherein the response comprises a denial of access to an application service corresponding to the application.

### EXAMPLE 10

A method of operating a service provider to enhance selective wipe capabilities, the method comprising: receiving notice of when devices become compromised; in an access control service that provides authentication and authorization services for a plurality of application services, receiving a request from an application to authenticate a user with respect to an application service corresponding to the application; in response to the request, the access control service determining if a device associated with the request has been identified as compromised; and the access control service responding to the request with a selective wipe signal when the device is identified as compromised and granting the application with access to the application service when the device is not identified as compromised.

### EXAMPLE 11

The method of Example 10 wherein responding to the request with the selective wipe signal comprises returning a token to the application that comprises the selective wipe signal, and wherein granting the application with access to the application service comprises returning a different token to the application that does not comprise the selective wipe signal.

### EXAMPLE 12

The method of Examples 10-11 wherein receiving the notice of when the devices become compromised comprises the access control service receiving the notice from a device management service.

### EXAMPLE 13

The method of Examples 10-12 wherein receiving the notice of when the devices become compromised comprises a device management service receiving the notices from at least a device management client and alerting the access control system that the devices have become compromised.

### EXAMPLE 14

The method of Examples 10-13 further comprising a device management service communicating another selective wipe signal to a device management application on the device when the device becomes compromised.

### EXAMPLE 15

A service provider architecture comprising: a plurality of application services that communicate with a plurality of client applications deployed on a plurality of client devices; a device management service that initiates a primary selective wipe process on any device of the plurality of client devices when the device becomes compromised; and an access control service that authorizes the plurality of client applications to access the plurality of application services and initiates a secondary selective wipe process on the device when a client application attempts to access an application service.

### EXAMPLE 16

The service provider architecture of Example 15 wherein the access control service authorizes the plurality of client applications to access the plurality of application services by communicating security tokens to the plurality of client applications for use when communicating with the plurality of application services.

### EXAMPLE 17

The service provider architecture of Examples 15-16 wherein the access control service initiates the secondary selective wipe process by communicating a security token that comprises a selective wipe signal and that prevents the client application from communicating with any of the plurality of application services.

### EXAMPLE 18

The service provider architecture of Examples 15-17 wherein the device management service informs the access control service when the device becomes compromised.

### EXAMPLE 19

The service provider architecture of Examples 15-18 wherein the device management service receives a report from a device management client when the device becomes compromised and responsively informs the access control service that the device has become compromised.

### EXAMPLE 20

The service provider architecture of Examples 15-19 wherein the plurality of client applications comprises a productivity application, a personal information management application, and a cloud storage application, and wherein the plurality of application services comprises a productivity service, a personal information management service, and a cloud storage service.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating a service provider to enhance selective wipe capabilities, the method comprising:
receiving notice of when devices become compromised;
in an access control service that provides authentication and authorization services for a plurality of application services, receiving a request from an application to authenticate a user with respect to an application service corresponding to the application;
in response to the request, the access control service determining if a device associated with the request has been identified as compromised; and
the access control service responding to the request with a selective wipe signal when the device is identified as compromised and granting the application with access to the application service when the device is not identified as compromised.

2. The method of claim 1 wherein responding to the request with the selective wipe signal comprises returning a token to the application that comprises the selective wipe signal, and wherein granting the application with access to the application service comprises returning a different token to the application that does not comprise the selective wipe signal.

3. The method of claim 1 wherein receiving the notice of when the devices become compromised comprises the access control service receiving the notice from a device management service.

4. The method of claim 1 wherein receiving the notice of when the devices become compromised comprises a device management service receiving the notices from at least a device management client and alerting the access control service that the devices have become compromised.

5. The method of claim 1 further comprising a device management service communicating another selective wipe signal to a device management application on the device when the device becomes compromised.

6. An apparatus comprising:
one or more computer readable storage media; and
program instructions stored on the one or more computer readable storage media and comprising an application that, when executed by a processing system, directs the processing system to at least:
initiate a request to authenticate a user with respect to the application;
receive a response to the request that includes a device management instruction; and
execute the device management instruction;

7. The apparatus of claim 6 wherein the device management instruction comprises a selective wipe instruction to selectively wipe data associated with the application and wherein the application further directs the processing system to communicate the request to authenticate the user to an access control service that provides authentication and authorization services, wherein the access control service returns the response to the request that includes the device management instruction.

8. The apparatus of claim 7 wherein the program instructions further comprise a device management application that, when executed by the processing system, directs the processing system to selectively wipe other data in response to another selective wipe instruction communicated by a device management service.

9. The apparatus of claim 8 further comprising the processing system configured to execute the program instructions, wherein the application initiates the request to authenticate the user with respect to the application when attempting to synchronize the data associated with the application with a copy of the data maintained by an application service corresponding to the application.

10. The apparatus of claim 9 wherein the data associated with the application comprises enterprise data and personal data, and wherein to selectively wipe the data associated with the application, the application directs the processing system to remove the enterprise data while preserving the personal data.

11. The apparatus of claim 10 wherein the application further directs the processing system to track which of the data associated with the application comprises the enterprise data and which of the data associated with the application comprises the personal data.

12. The apparatus of claim 6 wherein the program instructions further comprise a second application that, when executed by the processing system, directs the processing system to at least: initiate a second request to authenticate the user with respect to the second application; receive a second response to the second request that includes a second selective wipe instruction; and in response to the second request, selectively wipe second data associated with the second application.

13. The apparatus of claim 6 wherein the application comprises a productivity application, a personal information management application, or a cloud storage application.

14. The apparatus of claim 13 wherein the response comprises one of a denial of access to an application service corresponding to the application that includes a selective wipe instruction to selectively wipe data associated with the application and a device configuration instruction to configure a device in accordance with a device management policy.

15. A service provider architecture comprising:
a plurality of application services that communicate with a plurality of client applications deployed on a plurality of client devices;
a device management service that initiates a primary selective wipe process on any device of the plurality of client devices when the device becomes compromised; and
an access control service that authorizes the plurality of client applications to access the plurality of application services and initiates a secondary selective wipe process on the device when a client application on the device attempts to access an application service.

16. The service provider architecture of claim 15 wherein the access control service authorizes the plurality of client applications to access the plurality of application services by communicating security tokens to the plurality of client applications for use when communicating with the plurality of application services.

17. The service provider architecture of claim 16 wherein the access control service initiates the secondary selective wipe process by communicating a security token that comprises a selective wipe signal and that prevents the client application from communicating with any of the plurality of application services.

18. The service provider architecture of claim 15 wherein the device management service informs the access control service when the device becomes compromised.

19. The service provider architecture of claim 15 wherein the device management service receives a report from a device management client when the device becomes compromised and responsively informs the access control service that the device has become compromised.

20. The service provider architecture of claim 15 wherein the plurality of client applications comprises a productivity application, a personal information management application, and a cloud storage application, and wherein the plurality of application services comprises a productivity service, a personal information management service, and a cloud storage service.
